(19) United States
(12) Patent Application Publication
(10) Pub. No.: US 2012/0079139 A1
(43) Pub. Date: Mar. 29, 2012

(54) COMPUTER SYSTEM, APPARATUS, AND METHOD FOR CHECKING FOR CABLE MISCONNECTIONS

(75) Inventors: Yoshio SONOKAWA, Hadano (JP); Yoshinori WAKAI, Hadano (JP); Yutaka TAWARA, Hadano (JP)

(73) Assignee: HITACHI, LTD., Tokyo (JP)

(21) Appl. No.: 13/208,649

(22) Filed: Aug. 12, 2011

(30) Foreign Application Priority Data
Sep. 28, 2010 (JP) 2010-217564

(51) Int. Cl. G06F 3/00

(52) U.S. Cl. 710/16

(57) ABSTRACT

When checking whether or not the connection-destination port of a cable that is connected between apparatuses is correct, notification is made to a user by a control apparatus. The control apparatus identifies a second port that is the correct connection destination of a target first port, which is a check-target first port of multiple first ports, identifies a second port, which is connected via a cable to the target first port, and determines whether or not these second ports are the same. In a case where the result of this determination is negative, the control apparatus causes the second display apparatus to execute a display with respect to the second port that is the correct connection destination of the target first port.

This application relates to and claims the benefit of priority from Japanese Patent Application No. 2010-217564 filed on Sep. 28, 2010, the entire disclosure of which is incorporated herein by reference.

### BACKGROUND

The present invention relates to checking for cable misconnections between apparatuses carrying out data communications.

As conventional technology for checking whether or not the connection-destination port of a cable that is connected between apparatuses is correct, there is a first prior art (Japanese Patent Application Laid-open No. H5-134790) and a second prior art (Japanese Patent Application Laid-open No. H7-95246).

The first prior art is as follows. A transmission ID is set with respect to each port (connector) of a sending-side apparatus, and a reception ID is set with respect to each port of the receiving-side apparatus. The receiving-side apparatus comprises a connection status display part. The set transmission ID is sent from the port of the sending-side apparatus to the port of the receiving-side apparatus via a cable. The receiving-side apparatus compares the transmission ID from the sending-side apparatus to the reception ID set in the port (port of the receiving-side apparatus), which received this transmission ID. In a case where the comparison result shows a mismatch, the connection status display part of the receiving-side apparatus displays the fact that the cable is misconnected.

The second prior art is as follows. A transmission package (sending-side apparatus) sends transmission package sending-side connection information to a reception package (receiving-side apparatus). The reception package compares the sending-side connection information received via a cable to receiving-side connection information of the reception package, and notifies the result of the comparison to a higher-level system.

### SUMMARY

In the first prior art, the user can learn of a port to which a cable has been misconnected from the display of the connection status display part. However, the user cannot tell which port is the correct connection destination for this cable from the display of the connection status display part.

Furthermore, in the second prior art, the higher-level system is notified that there is a misconnection (abnormality). However, in the second prior art as well, the correct connection destination of the misconnected cable is not made clear.

Consequently, an object of the present invention is to notify the user of the correct connection destinations of respective cables when multiple cables are used to connect multiple ports of one or more first apparatuses to multiple ports of one or more second apparatuses.

One or more first apparatuses having multiple first ports, one or more second apparatuses, which are connected via multiple cables to the one or more first apparatuses, and which comprise multiple second ports and a second display apparatus, and a control apparatus are provided. The control apparatus comprises correct connection management information denoting identification information of a second port, which is the correct connection destination of a first port, for each first port. The control apparatus (A) identifies from the correct connection management information the identification information of the second port that is the correct connection destination of a target first port, which is the check-target first port of the multiple first ports, (B) identifies the identification information of the second port, which is connected via cable to the target first port, and (C) determines the correctness or incorrectness of the second port which is a connection destination of the target first port, based on the second port identification information identified in the above-mentioned (A) and the second port identification information identified in the above-mentioned (B). In a case where the result of the determination made in the above-mentioned (C) is negative, the control apparatus causes the second display apparatus to execute a display with respect to the second port identified from the second port identification information identified in the above-mentioned (A).

At this point, the control apparatus may be provided in at least one of the first apparatus or the second apparatus, or may be provided externally of the first apparatus and the second apparatus. The control apparatus can acquire from either one of the first apparatus or the second apparatus identification information of the second port connected to the target first port. Either the first or second apparatus may acquire via the cable connected to the target first port the identification information of the second port connected to the target first port, and may transfer the acquired identification information to the control apparatus.

The second display apparatus may be multiple display parts respectively corresponding to multiple second ports, or may be a display apparatus that is common to multiple second ports.

According to the present invention, it is possible to notify the user of the correct connection-destination ports of respective cables when multiple cables are used to connect multiple ports of one or more first apparatuses to multiple ports of one or more second apparatuses.

### BRIEF DESCRIPTION OF THE DRAWINGS

FIG. 1 is a block diagram of an entire system related to Example 1 of the present invention;

FIG. 2 is a functional block diagram of a server chassis and I/O expansion apparatuses;

FIG. 3 shows the configuration of a correct connection destination table 129;

FIG. 4 shows the configuration of a destination management table;

FIG. 5 is a block diagram of a system in which a cable is misconnected;

FIG. 6 shows an example of the displays in the system in which a cable is misconnected;

FIG. 7 shows that the displays are turned OFF after the cable has been connected correctly;

FIG. 8 is a flowchart of a process for checking for a cable misconnection;

FIG. 9 is a flowchart of the processing of a port specifying part 204;

FIG. 10 is a flowchart of the processing of a correct connection destination information processing part 205;

FIG. 11 is a flowchart of the processing of a connection destination reading part 207;

FIG. 12 is a flowchart of the processing of a comparison part 206;

FIG. 13 is a flowchart of the processing of an internal apparatus display setting part 209;

FIG. 14 is a flowchart of the processing of an external apparatus display setting part 208;

FIG. 15 is a flowchart of the processing of a reception display setting part 218;

FIG. 16 is a system block diagram in Example 2 of the present invention when the port of the server chassis side, which is performing a misconnection check, is not connected via a cable to the port of the I/O expansion apparatus side;

FIG. 17 shows an example of the displays in Example 3 of the present invention when a cable is misconnected;

FIG. 18 is a flowchart of the processing of the external apparatus display setting part 208 in Example 3;

FIG. 19 is a flowchart of the processing of the reception display setting part 218 in Example 3;

FIG. 20 is a flowchart of lighting mode switching in Example 4 of the present invention;

FIG. 21 is a flowchart of the processing of the internal apparatus display setting part 209 in Example 4; and

FIG. 22 is a flowchart of the processing of the external apparatus display setting part 208 in Example 4.

### DETAILED DESCRIPTION OF THE EMBODIMENT

A number of examples of the present invention will be explained below by referring to the drawings.

Furthermore, in the following explanation, various types of information may be explained using the expression “xxx table”, but the various types of information may also be expressed using a data structure other than a table. To show that the various information is not dependent on the data structure, “xxx table” can be called “xxx information”.

Furthermore, in the following explanation, there may be cases where processing is explained having a “program” as the subject of the sentence, but since the stipulated processing is performed in accordance with a program being executed by a processor (for example, a CPU (Central Processing Unit)) while using a storage resource (for example, a memory) and/or a communication interface device (for example, a communication port) as needed, the processor may also be considered the subject of the processing. Processing, which is explained having the program as the subject of the sentence, may be carried out by the processor or the system comprising this processor (for example, a server chassis, a pre-controller, an I/O expansion apparatus, or a post-controller, which will be described further below). Also, the processor may be the CPU itself, or may comprise a hardware circuit that carries out either all or a portion of the processing performed by the processor. The program may be installed in respective controllers from a program source. The program source, for example, may be either a program delivery server or a computer-readable storage medium.

Furthermore, in the following explanation, a number or an ID will be used as types of identification information for various elements (for example, the server chassis, the pre-controller, the post-controller, or the port), but these numbers or IDs may be interchangeable, or a combination of multiple types of identification information may be the identification information.

### Example 1

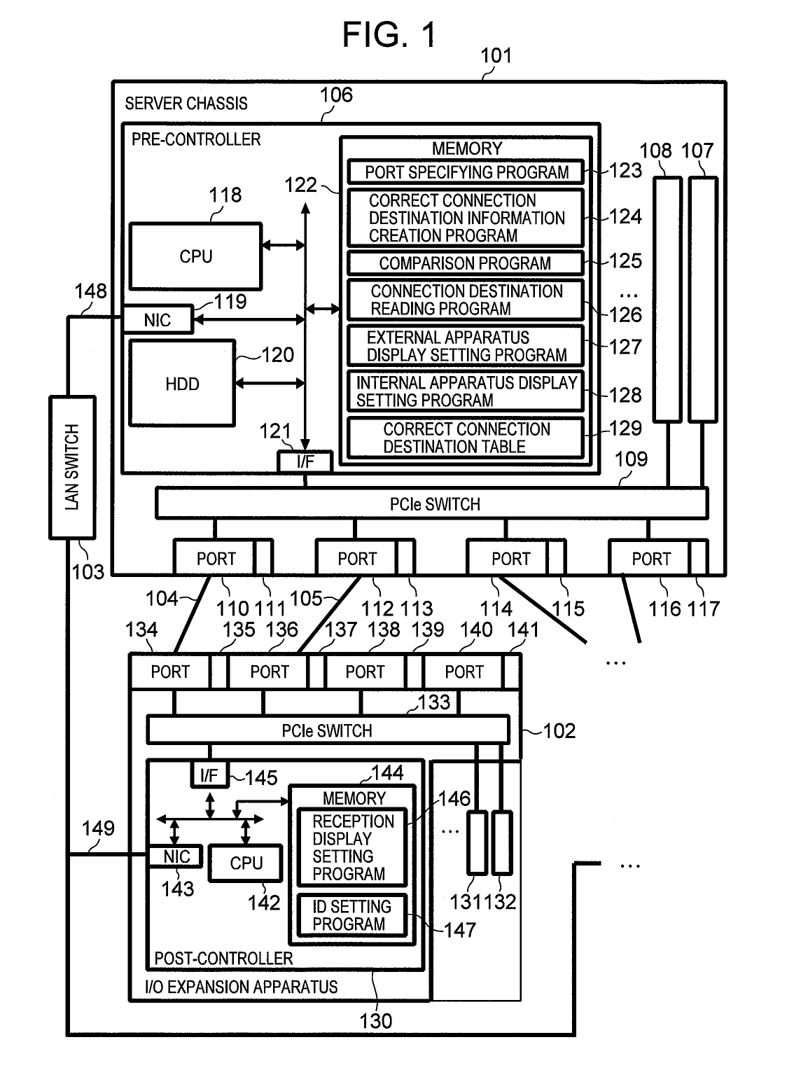

FIG. 1 is a block diagram of an entire system related to Example 1 of the present invention.

This system is a computer system, and multiple I/O expansion apparatuses 102 are coupled to one (or multiple) server chassis 101.

Inside the server chassis 101, a pre-controller 106 and blades 107 and 108 for checking for a misconnection are coupled to ports 110, 112, 114, and 116 via a PCIe (Peripheral Component Interconnect Express) switch 109. Each port (or in the vicinity of each port) respectively comprises a display part 111, 113, 115 and 117. In the pre-controller 106, a CPU (Central Processing Unit) 118, a NIC (Network Interface Card) 119, a HDD (Hard Disk Drive) 120, an I/F (Interface) 121 with the PCIe switch 109, and a memory 122 are coupled via a bus.

Inside the memory 122 are stored a port specifying program 123, a correct connection destination information creation program 124, a comparison program 125, a connection destination reading program 126, an external apparatus display setting program 127, an internal apparatus display setting program 128, and a correct connection destination table 129. The programs 123 through 128 are executed in accordance with being read into the CPU 118.

Inside the I/O expansion apparatus 102, a post-controller 130 for checking for misconnections and ports 134, 136, 138 and 140 are coupled via a PCIe switch 133. I/O devices (for example, HBAs (Host Bus Adapters)) 131 and 132 are coupled to the PCIe switch 133. Each port (or in the vicinity of each port) respectively comprises a display part 135, 137, 139 and 141. In the post-controller 130, a CPU 142, a NIC 143, a memory 144, and a I/F 145 are coupled via a bus. Then, the I/F 145 and the PCIe switch 133 are coupled via a bus.

Inside the memory 144 there are stored a reception display setting program 146 and an ID setting program 147. The programs 146 and 147 are executed by being read into the CPU 142.

Furthermore, the pre-controller 106 inside the server chassis 101 is coupled to the post-controller 130 inside the I/O expansion apparatus 102 via a LAN cable 148, a LAN switch 103, and a LAN cable 149.

The respective ports of the server chassis 101 and the respective ports of the I/O expansion apparatus 102 are connected on a one-to-one basis by cables. Furthermore, the server chassis 101 can be coupled to multiple I/O expansion apparatuses.

In this example, the server chassis 101 and the I/O expansion apparatus 102 each comprise one LAN port (NIC 119 and 143) for communications separate from the above-mentioned ports. The reason for providing the LAN ports is to notify the user of information (hereinafter, connection support information) denoting a correct connection destination and/or a misconnection via the LAN cables 148 and 149. Specifically, this is because when the connection support information is notified via the cables connecting the ports of the server chassis 101 to the ports of the I/O expansion apparatus 102, it will happen that the connection support information will not be able to be communicated normally via a cable that is misconnected. Also, in this example, to prevent the misconnection of a LAN cable, the server chassis 101 (pre-controller 106) and the I/O expansion apparatus 102 (post-controller 130) only comprise one LAN port (NIC) each. However, multiple LAN ports may be provided in at least one of the server chassis 101 or the I/O expansion apparatus 102. Furthermore, the LAN switch 103 may be used when connecting multiple server chassis 101 to multiple I/O expansion apparatuses 102 using LAN cables. Furthermore, a communication path that differs from the communication path via a cable may be a communication path other than LAN, and, similarly, the communication interface of this different communication path is not limited to LAN, but rather may be another type of communication interface.

An apparatus ID of the correct connection-destination I/O expansion apparatus 102 and the number of the correct connection-destination port are associated in the correct connection destination table 129 for each port number of the server chassis 101.

Furthermore, the server chassis 101 creates an IP address corresponding to each apparatus ID (I/O expansion apparatus 102) of the correct connection destination table 129. The memory 122 stores a destination management table (not shown in the drawing) comprising information denoting the corresponding relationship between an I/O expansion apparatus 102 and an IP address.

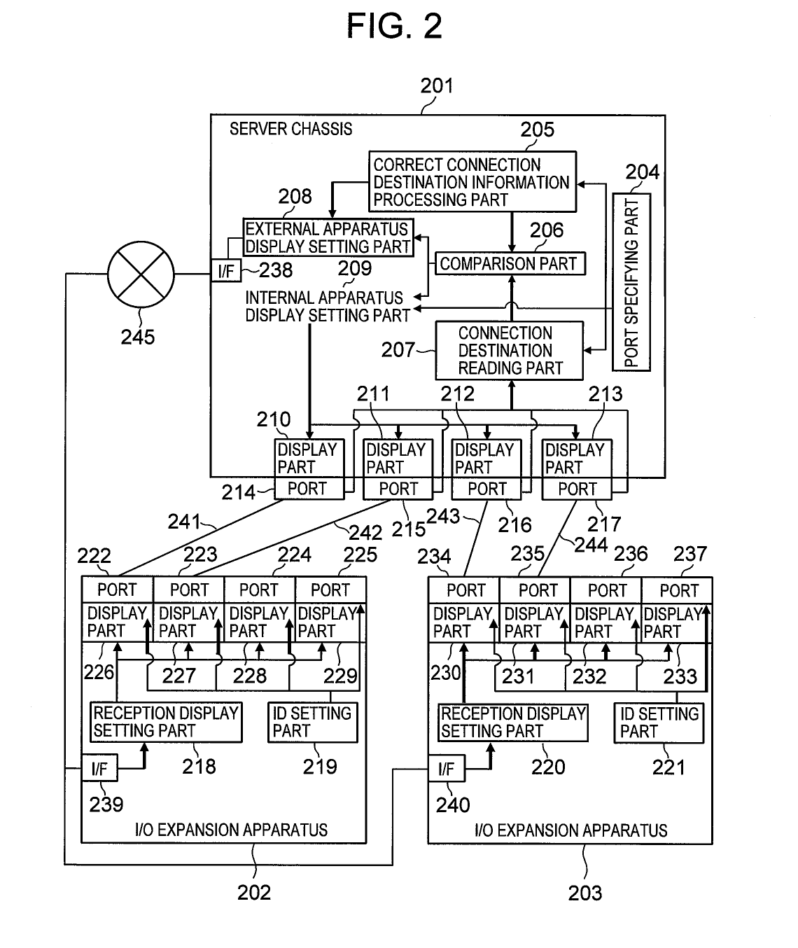

FIG. 2 is a functional block diagram of a server chassis and I/O expansion apparatuses. Furthermore, the reference signs shown in FIG. 2 and subsequent drawings and the reference signs shown in FIG. 1 may differ even when the name of the element is the same, but even though the reference signs differ, when the name is the same, it is the same type element.

A server chassis 201 comprises ports 214, 215, 216, and 217, and display parts 210, 211, 212, and 213 for each port. Furthermore, the display parts 210 through 213 may be LEDs (Light Emitting Diodes) or simple light-emitting devices such as miniature light bulbs (simple display devices). In this example, a display apparatus is configured using multiple display parts each corresponding to multiple ports, but the display apparatus may also be a single advanced apparatus capable of displaying either characters or images. In accordance with this, this display apparatus may display information denoting the location of a misconnected port.

A pre-controller can comprise the functions shown in the drawing of the pre-controller by the CPU 118 reading and executing the respective programs from the memory 122. The functions, for example, include a port specifying part 204, a correct connection destination information processing part 205, a comparison part 206, a connection destination reading part 207, an external apparatus display setting part 208, and an internal apparatus display setting part 209. An explanation of each function will be given further below.

An I/O expansion apparatus 202 comprises ports 222, 223, 224, and 225, and display parts 226, 227, 228, and 229 for each port. Furthermore, the display parts 226 through 229 may be LEDs or simple light-emitting devices such as miniature light bulbs (simple display devices). In this example, a display apparatus is configured using multiple display parts each corresponding to multiple ports, but the display apparatus may also be a single advanced apparatus capable of displaying either characters or images. In accordance with this, this display apparatus may display information denoting the location of a correct connection-destination port.

A post-controller can comprise the functions shown in the drawing of the post-controller by the CPU 142 reading and executing the respective programs from the memory 144. The functions, for example, include a reception display setting part 218 and an ID setting part 219. An explanation of each function will be given further below.

Since the functions of the I/O expansion apparatus 203 are the same as those of the I/O expansion apparatus 202, an explanation of the I/O expansion apparatus 203 will be omitted hereinafter.

The pre-controller of the server chassis 101 is connected to the post-controller of the I/O expansion apparatuses 102 via cables 241, 242, 243, and 244. Furthermore, the pre-controller is connected to the post-controller in accordance with a LAN cable via I/Fs 238, 239 and 240 and a LAN switch 245.

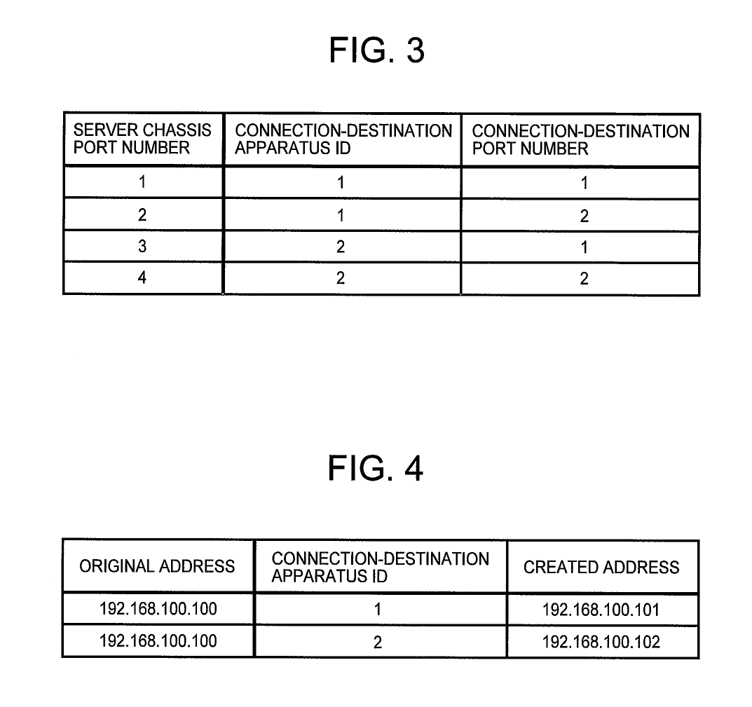

FIG. 3 shows the configuration of the correct connection destination table 129.

The correct connection destination table 129 shows which port of which I/O expansion apparatus should be connected to which port of the server chassis 101. The correct connection destination table 129 comprises the following information for each server chassis 101 port:

(1) a server chassis port number, which is the identification number of the port of the server chassis 101;

(2) a connection-destination apparatus ID, which is the identification information of the I/O expansion apparatus 102; and

(3) a connection-destination port number, which is the identification number of the I/O expansion apparatus 102 port. Information made up of the information of the above-mentioned (2) and (3) will be referred to below as “correct connection destination information”. Therefore, there is correct connection destination information for each port of the server chassis 101.

Furthermore, the correct connection destination table 129 is stored beforehand prior to operating the computer system shown in FIG. 1. Also, information registered in the correct connection destination table 129 may be information that the user has inputted manually, or information that the server chassis 101 determined automatically in accordance with a prescribed rule.

According to the correct connection destination information corresponding to server chassis port “1”, it is clear that the port of port number “1” in the I/O expansion apparatus of connection-destination apparatus ID “1” should be connected to the port of server chassis port number “1”.

FIG. 4 shows the configuration of a destination management table. Furthermore, it is supposed that the original IP address is stored beforehand by the correct connection destination information processing part 205.

The destination management table comprises an original IP address, a connection-destination apparatus ID, and a created address for each I/O expansion apparatus. This table, for example, is created as described hereinbelow.

First, the correct connection destination information processing part 205 identifies the connection-destination apparatus ID corresponding to the port number n (where n is an integer) from the correct connection destination table 129. Next, the correct connection destination information processing part 205 identifies the original IP address, which corresponds to this connection-destination apparatus ID, and creates a unique IP address for the I/O expansion apparatus corresponding to above-mentioned identified connection-destination apparatus ID by adding (or subtracting) the value of this connection-destination apparatus ID to (from) the identified IP address. For example, the original IP address is “192.168.100.100”, and in a case where the connection-destination apparatus ID is “1”, the correct connection destination information processing part 205 creates “192.168.100.101” by adding “1” to the host part of the original IP address. The I/O expansion apparatus 102 here is assumed to have stored the same original IP address beforehand, and creates and sets its own IP address using the same rule. In accordance with this, it becomes possible for the server chassis 101 and the respective I/O expansion apparatuses 102 to communicate using the IP address. Furthermore, the original IP address may be the server chassis 101 IP address, or may be set manually by the user. Also, the processing of the original IP address using the connection-destination apparatus ID is not limited to addition or subtraction. The method for the I/O expansion apparatus to create the unique IP address is not limited to a method that uses the connection-destination apparatus ID and the original IP address.

The respective functions of the pre-controller in the server chassis 101 will be explained below by returning to FIG. 2.

The port specifying part 204 specifies a port number n (where n is an integer), and sends the specified port number n to the correct connection destination information processing part 205, the internal apparatus display setting part 209, and the connection destination reading part 207. The port number n is either a port number that has been inputted from a machine (for example, an input device or a remote computer) operated by the user, or an automatically specified port number, and is the number of a server chassis 101 port.

The correct connection destination information processing part 205 identifies from the correct connection destination table the correct connection destination information corresponding to the port number n which is specified from the port specifying part 204, and sends the identified correct connection destination information to the comparison part 206. Further, the correct connection destination information processing part 205 creates and manages the destination management table for managing the apparatus ID of the I/O expansion apparatus and the IP address set for this apparatus as a set. The correct connection destination information processing part 205 also identifies the IP address corresponding to the connection-destination apparatus ID within the above-mentioned identified correct connection destination information from the destination management table, and sends the identified IP address and the above-mentioned identified correct connection destination information to the external apparatus display setting part 208.

The connection destination reading part 207 sends to the comparison part 206 an actual connection destination information corresponding to the port number n which is specified from the port specifying part 204. Specifically, the connection destination reading part 207 acquires the actual connection destination information configured using the following information (a) and (b) via the port of the specified port number n (a port of the server chassis 101):

(a) an apparatus ID (connection-destination apparatus ID) of the I/O expansion apparatus actually connected via a cable to the port of port number n (a server chassis 101 port); and

(b) a number (connection-destination port number) of the port (I/O expansion apparatus port) actually connected via a cable to the port of port number n (a server chassis 101 port). The information (b) is acquired from the port (I/O expansion apparatus port) connected via a cable to the port of port number n. The information (a) is acquired from an ID setting part (for example, 219) through the port (I/O expansion apparatus port) connected via a cable to the port of port number n. The connection destination reading part 207 sends the actual connection destination information configured in the information (a) and (b) to the comparison part 206.

The comparison part 206 compares the correct connection destination information corresponding to port number n to the actual connection destination information, and sends the result of this comparison to the external apparatus display setting part 208 and the internal apparatus display setting part 209.

The internal apparatus display setting part 209, in a case where the comparison result received from the comparison part 206 signifies a mismatch, instructs the display part to execute a display corresponding to port number n.

The external apparatus display setting part 208, in a case where the comparison result received from the comparison part 206 signifies a mismatch, sends the correct connection destination information received from the correct connection destination information processing part 205 using the IP address received from the correct connection destination information processing part 205 as the destination via the I/F 238. This IP address is the correct connection-destination I/O expansion apparatus corresponding to port number n. For this reason, the correct connection destination information is sent to the correct connection-destination I/O expansion apparatus via the LAN 245 (LAN cable). A reception display setting part (for example, 218) in this I/O expansion apparatus receives this correct connection destination information. This correct connection destination information comprises the number (the connection-destination port number corresponding to port number n) of the correct connection-destination port in the I/O expansion apparatus (for example, 202).

The respective functions of the post-controller in the I/O expansion apparatus 102 will be explained below.

The ID setting part 219 creates and sets an IP address for the relevant apparatus based on the apparatus ID preset in the IO expansion apparatus comprising this ID setting part 219.

The reception display setting part 218 receives the correct connection destination information from the external apparatus display setting part 208 of the server chassis, and instructs the display part near the port corresponding to the connection-destination port number included in this information to execute a display. The reception display setting part 218 also stores the IP address of the relevant apparatus created by the ID setting part 219.

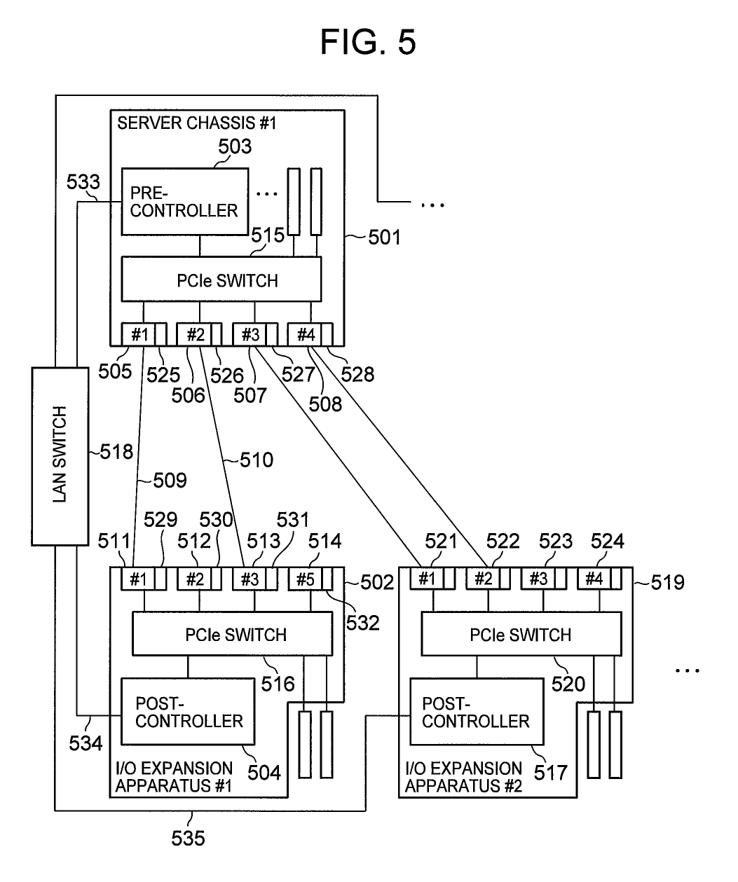

FIG. 5 is a block diagram of a system in which a cable has been misconnected.

A port 505 provided in the server chassis 501 and a port 511 provided in the I/O expansion apparatus 502 are correctly connected by a cable 509. Alternatively, a port 506 provided in the server chassis 501 and a port 513 provided in the I/O expansion apparatus 502 are incorrectly connected by a cable 510. Actually, the port 506 provided in the server chassis 501 should be connected to the port 512 provided in the I/O expansion apparatus 502.

It is supposed here that “2” has been specified to the pre-controller 503 as the port number to undergo a misconnection check. The pre-controller 503 identifies from the correct connection destination table 129 shown in FIG. 3 the connection-destination apparatus ID “1” and the connection-destination port number “2” corresponding to the server chassis port number “2”. The information comprising these connection-destination apparatus ID “1” and connection-destination port number “2” is regarded as “correct connection destination information A”. Then, the pre-controller 503 reads the number “3” of the port 513, which is the actual connection destination, from the register of the port 513 of the I/O expansion apparatus 502 via the PCIe switch 515, the port 506 corresponding to the server chassis port number “2”, and the cable 510. In addition, the pre-controller 503 acquires the apparatus ID “1” of the I/O expansion apparatus set in the post-controller via the PCIe switch 515, the port 506 corresponding to the server chassis port number “2”, the cable 510, the I/O expansion apparatus port 513, and the PCIe switch 516. The information comprising this apparatus ID “1” and port number “3” is regarded as “actual connection destination information A”. Next, the pre-controller 503 compares the apparatus ID “1” and the port number “2” of the correct connection destination information A to the apparatus ID “1” and the port number “3” of the actual connection destination information A, and determines whether or not there is a match. Since the result of this is that there is a mismatch (since the port numbers do not match even though the apparatus IDs do match), the pre-controller 503 lights the display part 526 of the port 506 corresponding to the server chassis port number “2” that underwent the check.

The pre-controller 503 also creates a correct connection-destination apparatus IP address “192.168.100.101” by adding a “1”, which is the value of the correct connection-destination apparatus ID, to the host part of the original IP address “192.168.100.100”.

Similarly, the post-controller 504 of the I/O expansion apparatus 502 also creates and sets the relevant I/O expansion apparatus IP address “192.168.100.101” by adding a “1”, which is the value of the relevant I/O expansion apparatus ID, to the host part of the original IP address “192.168.100.100”. The pre-controller 503 of the server chassis 501 sends the information of the correct connection-destination port number “2” to the apparatus of the IP address “192.168.100.101”, that is, the post-controller 504 of the I/O expansion apparatus 502 via a LAN cable 533, a LAN switch 518, and a LAN cable 534. The post controller 504 of the I/O expansion apparatus 502 that receives the correct port number “2” information lights up the display part 530 of the port 512 corresponding to the port number “2”.

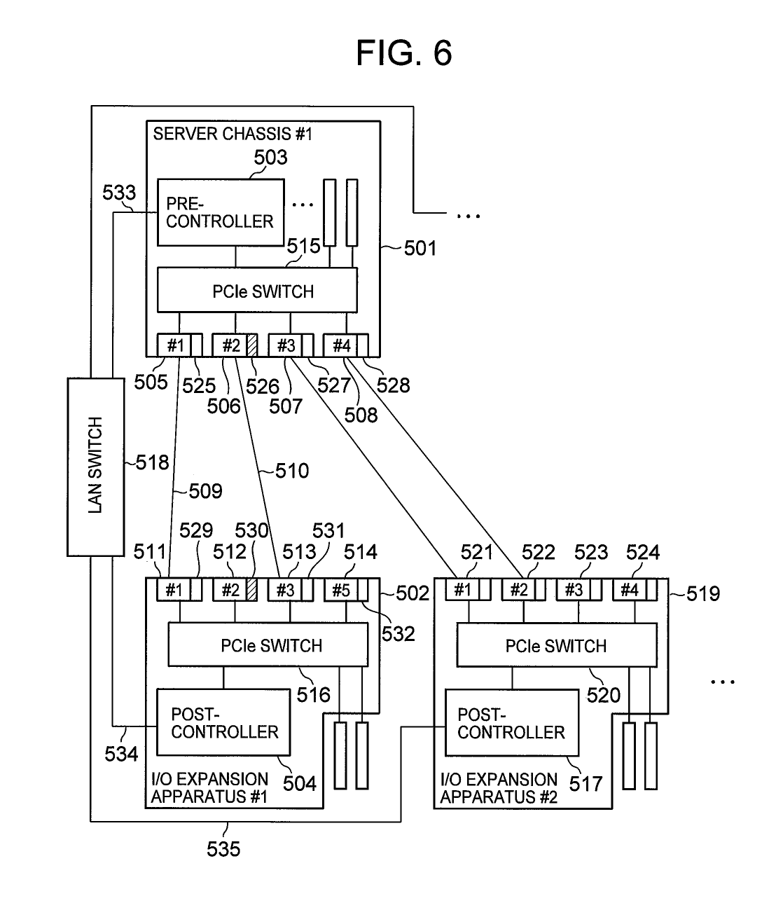

By the processing explained above by referring to FIG. 5, the display part 526 of the port 506 of the server chassis 501 and the display part 530 of the port 512 of the I/O expansion apparatus 502 are lit as shown in FIG. 6. In accordance with this, the user can tell that the misconnected port and cable are port 506 and cable 510. The user also can tell that the port 512 of the I/O expansion apparatus 502 is the correct correction destination of the cable 510.

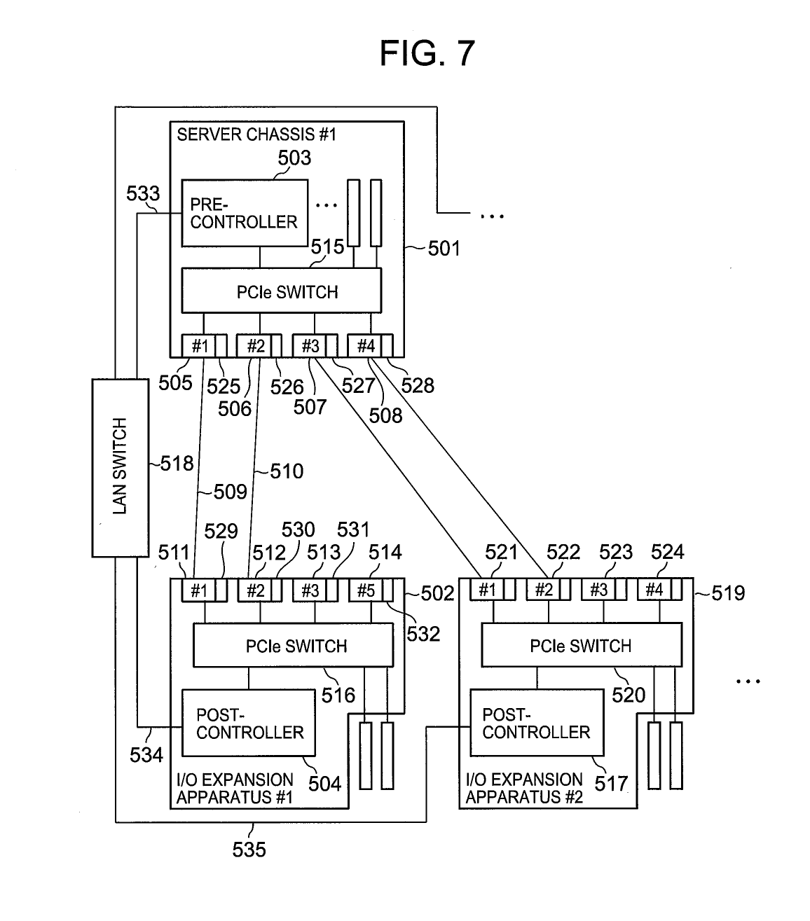

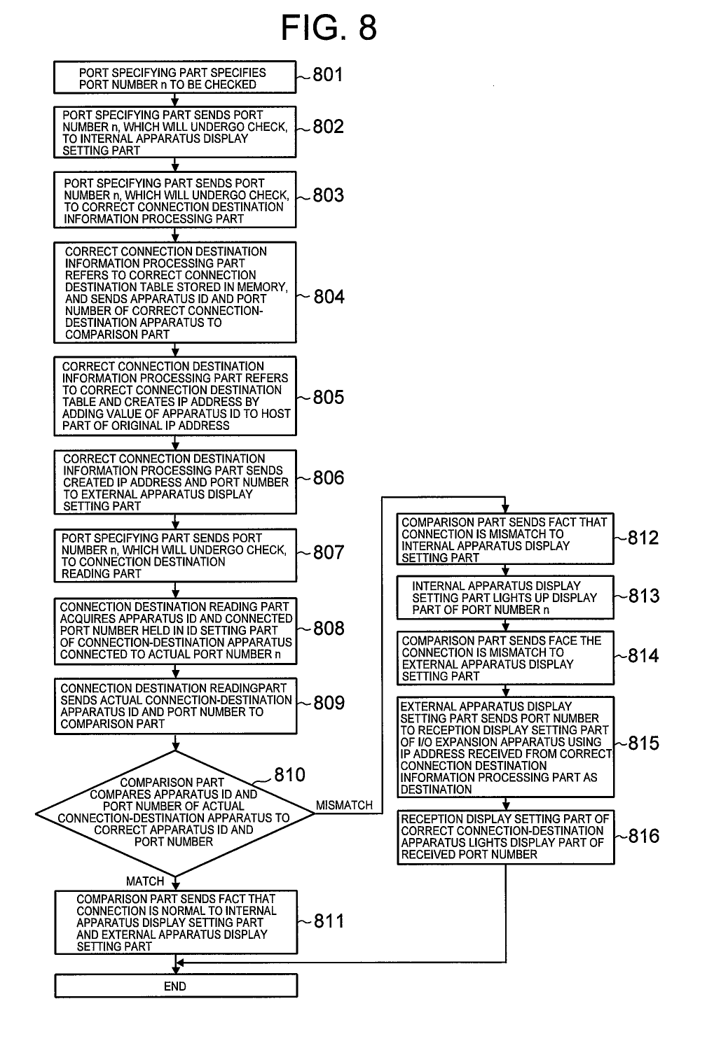

Therefore, to make the connection destination of the cable 510 connected to port 506 the correct connection destination, the user can connect the cable 510 from the port 513 to the port 512 as shown in FIG. 7. After the cable 510 has been connected correctly like this, the pre-controller 503 turns OFF the display part 526, and the post-controller 504 turns OFF the display part 530. This lets the user know that the connection has been corrected.

Furthermore, the fact that the cable 510 is correctly connected is detected by the pre-controller 503 once again carrying out the misconnection check as explained by referring to FIG. 5. This is because in this misconnection check, the apparatus ID and port number in the correct connection destination information match up with the apparatus ID and port number in the actual connection destination information.

FIG. 8 is a flowchart of a cable misconnection check process.

First, the port specifying part 204 specifies the port number n of the server chassis to undergo the misconnection check (Step 801).

Next, the port specifying part 204 sends the server chassis port number n to be checked to the internal apparatus display setting part 209 (Step 802).

Next, the port specifying part 204 sends the server chassis port number n to be checked to the correct connection destination information processing part 205 (Step 803).

Next, the correct connection destination information processing part 205 identifies the connection-destination apparatus ID and the connection-destination port number corresponding to port number n from the correct connection destination table 129, and sends the correct connection destination information comprising the identified connection-destination apparatus ID and connection-destination port number to the comparison part 206 (Step 804).

Next, the correct connection destination information processing part 205 identifies the original IP address corresponding to the apparatus ID identified in Step 804 from the destination management table. Then, the correct connection destination information processing part 205 creates a unique IP address for the apparatus ID (the correct connection-destination I/O expansion apparatus) identified above by adding the value of the above-identified apparatus ID to the host part of the above-identified IP address (Step 805).

Next, the correct connection destination information processing part 205 sends the above-created IP address and the above-mentioned correct connection destination information to the external apparatus display setting part 208 (Step 806).

Next, the port specifying part 204 sends the port number n to the connection destination reading part 207 (Step 807).

The connection destination reading part 207 acquires the apparatus ID of the relevant I/O expansion apparatus and the number of the connection-destination port of the port number n port from the I/O expansion apparatus actually connected via a cable to the port number n port (Step 808).

Next, the connection destination reading part 207 sends the actual connection destination information comprising the acquired apparatus ID and port number to the comparison part 206 (Step 809).

Next, the comparison part 206 compares the correct connection destination information to the actual connection destination information (Step 810). In a case where the comparison result here is a match, the comparison part 206 proceeds to Step 811, and in a case where the comparison result is a mismatch, moves to Step 812.

In a case where the comparison result is match in Step 810, the comparison part 206 sends information denoting the fact that the connection is normal to the internal apparatus display setting part 209 and the external apparatus display setting part 208 (Step 811). In accordance with this, the internal apparatus display setting part 209 does not light up the display part near the port of port number n, and the external apparatus display setting part 208 does not send the correct connection destination information corresponding to port number n using the IP address received in Step 806 as the destination.

In a case where the result of the comparison in Step 810 is mismatch, the comparison part 206 sends information denoting the fact that the connection is a mismatch to the internal apparatus display setting part 209 (Step 812).

Next, the internal apparatus display setting part 209 instructs the display part of the port number n port (210, 211, 212 or 213) to execute a display (Step 813). In accordance with this, the display part near the port number n port lights up.

Next, the comparison part 206 sends information denoting that the connection is a mismatch to the external apparatus display setting part 208 (Step 814).

Next, the external apparatus display setting part 208 sends the correct connection destination information received in Step 806 (at least the correct connection-destination port number) using the IP address received in Step 806 as the destination (Step 815). In accordance with this, this correct connection destination information is sent to the reception display setting part 218 of the correct connection-destination I/O expansion apparatus via the LAN.

Next, the reception display setting part 218 of the I/O expansion apparatus that received the correct connection destination information instructs the display part (222, 223, 224 or 225) of the port of the correct connection-destination port number inside the received correct connection destination information to execute a display (Step 816). In accordance with this, the display part near the port of the correct connection-destination port number lights up.

Furthermore, the information sent to the I/O expansion apparatus may be the correct connection-destination port number of the correct connection destination information only. Further, the I/O expansion apparatus, upon receiving the correct connection destination information via the LAN, may determine whether or not the apparatus ID in this correct connection destination information matches the apparatus ID in this I/O expansion apparatus. In a case where the determination is that there is a mismatch, the I/O expansion apparatus may send an error message to the server chassis 101.

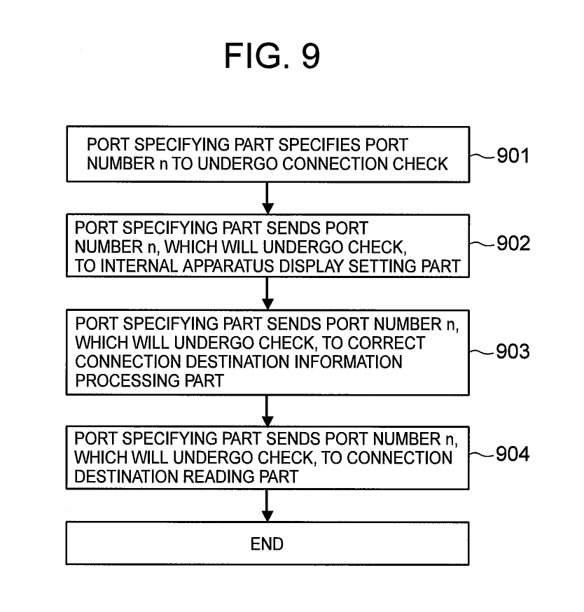

FIG. 9 is a flowchart of the processing of the port specifying part 204.

First, the port specifying part 204 determines the server chassis port number n to undergo a misconnection check (Step 901). Furthermore, the port number n determination, for example, may be specified automatically by the port specifying part 204 in accordance with a prescribed rule (for example, may be specified in order by adding 1 to each of the smallest port numbers (for example, 1)), or a port number may be manually specified by the user.

Next, the port specifying part 204 sends the specified port number n to the internal apparatus display setting part 209 (Step 902).

Next, the port specifying part 204 sends the specified port number n to the correct connection destination information processing part 205 (Step 903).

Next, the port specifying part 204 sends the specified port number n to the connection destination reading part 207 (Step 904).

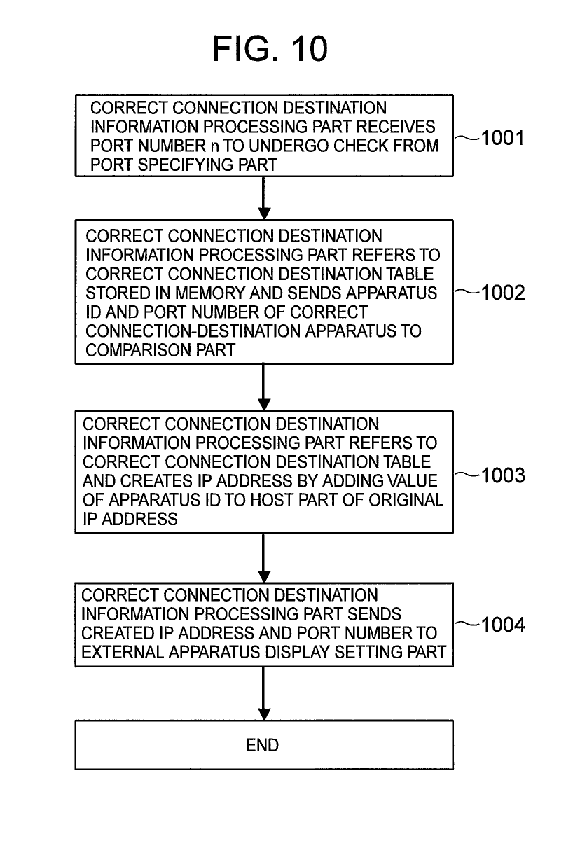

FIG. 10 is a flowchart of the processing of the correct connection destination information processing part 205.

First, the correct connection destination information processing part 205 receives a port number n from the port specifying part 204 (Step 1001).

Next, the correct connection destination information processing part 205 identifies from the correct connection destination table the connection-destination apparatus ID and the connection-destination port number corresponding to the port number n, and sends correct connection destination information comprising the identified connection-destination apparatus ID and the connection-destination port number to the comparison part 206 (Step 1002).

Next, the correct connection destination information processing part 205 identifies the original IP address corresponding to the apparatus ID identified in Step 1002. Then the correct connection destination information processing part 205 creates a unique IP address for this apparatus ID (the correct connection-destination I/O expansion apparatus) by adding the above-identified apparatus ID to the host part of this IP address (Step 1003).

Next, the correct connection destination information processing part 205 sends the IP address created above and the correct connection destination information (at least the connection-destination port number) to the external apparatus display setting part 208 (Step 1004).

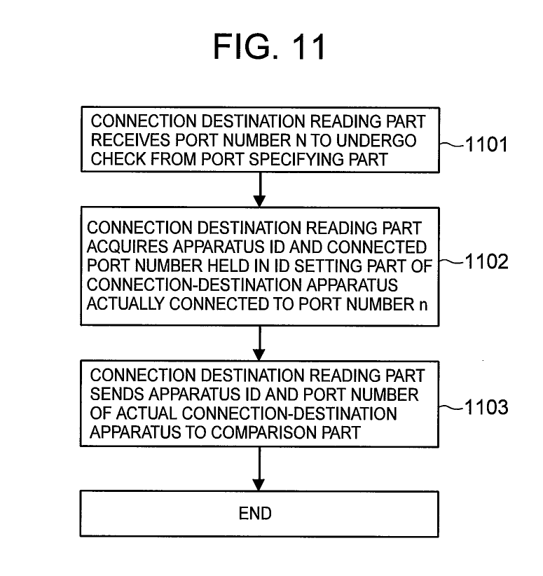

FIG. 11 is a flowchart showing the processing of the connection destination reading part 207.

First, the connection destination reading part 207 receives a port number n from the port specifying part 204 (Step 1101).

Next, the connection destination reading part 207 acquires via cable from the actual connection-destination I/O expansion apparatus, which is connected via this cable to the port of this port number n, the apparatus ID of this I/O expansion apparatus and the number of the port to which the cable is actually connected (Step 1102).

Next, the connection destination reading part 207 sends actual connection destination information comprising the apparatus ID and the port number acquired in Step 1102 to the comparison part 206 (Step 1103).

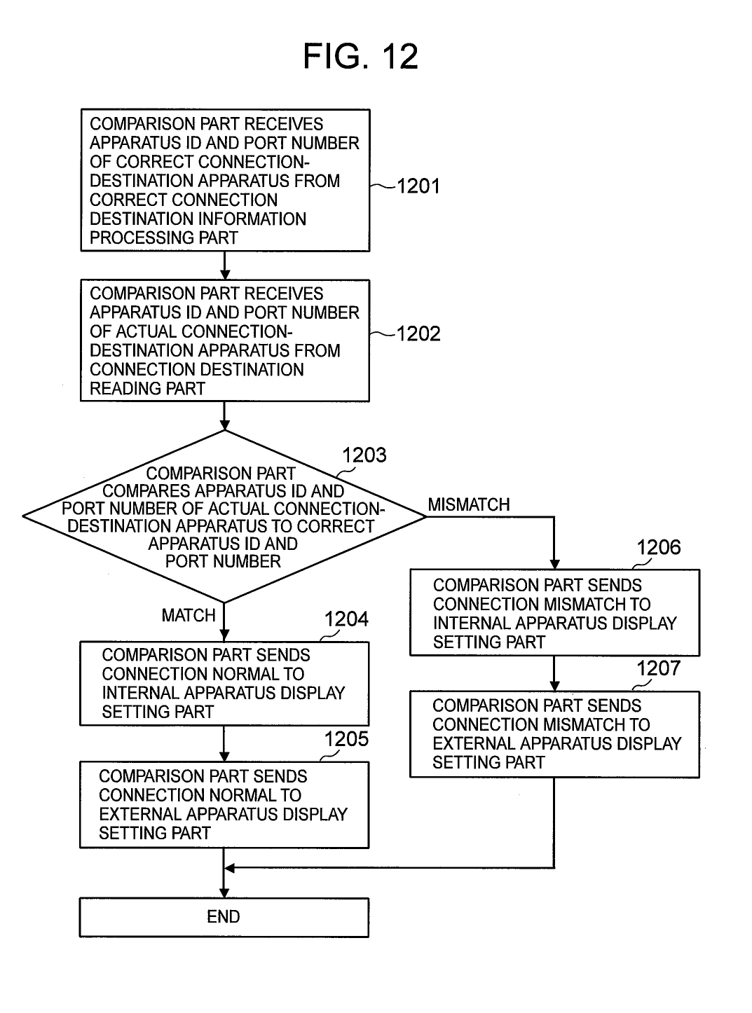

FIG. 12 is a flowchart of the processing of the comparison part 206.

First, the comparison part 206 receives correct connection destination information from the correct connection destination information processing part 205 (Step 1201).

Next, the comparison part 206 receives actual connection destination information from the connection destination reading part 207 (Step 1202).

Next, the comparison part 206 compares the correct connection destination information to the actual connection destination information (Step 1203).

In a case where the result of the comparison of Step 1202 is match, the comparison part 206 sends information denoting the fact that the connection is normal to the internal apparatus display setting part 209 and the external apparatus display setting part 208 (Steps 1204 and 1205).

Alternatively, in a case where the result of the comparison of Step 1202 is mismatch, the comparison part 206 sends information denoting the fact that the connection is a mismatch to the internal apparatus display setting part 209 and the external apparatus display setting part 208 (Steps 1206 and 1207).

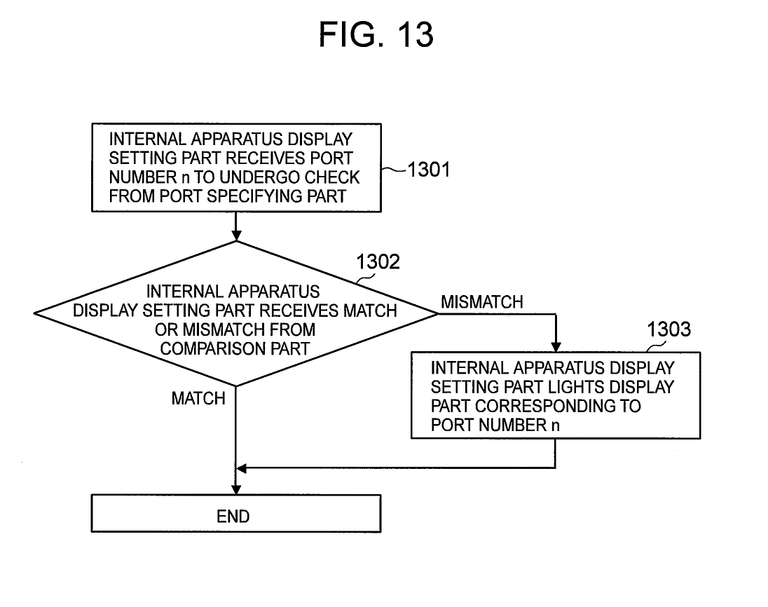

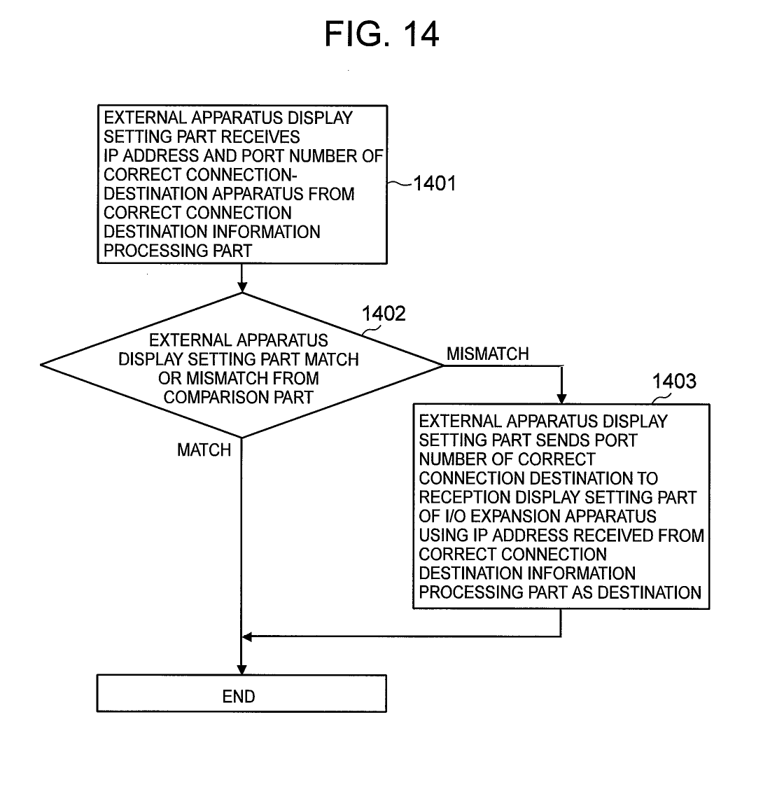

FIG. 13 is a flowchart of the processing of the internal apparatus display setting part 209.

First, the internal apparatus display setting part 209 receives a port number n from the port specifying part 204 (Step 1301).

Next, the internal apparatus display setting part 209 receives a comparison result from the comparison part 206 (Step 1302).

In a case where the comparison result received in Step 1302 is mismatch, the internal apparatus display setting part 209 instructs the display part (210, 211, 212, or 213) of the port of the server chassis port number n to execute a display (Step 1303).

FIG. 14 is a flowchart of the processing of the external apparatus display setting part 208.

First, the external apparatus display setting part 208 receives correct connection destination information from the correct connection destination information processing part 205 (Step 1401).

Next, the external apparatus display setting part 208 receives a comparison result from the comparison part 206 (Step 1402).

In a case where the comparison result received in Step 1402 is mismatch, the external apparatus display setting part 208 sends the correct connection destination information (for example, the connection-destination port number only) using the IP address received from the correct connection destination information processing part 205 as the destination (Step 1403). In accordance with this, this correct connection destination information is sent to the reception display setting part 218 of the correct connection-destination I/O expansion apparatus of the port number n port.

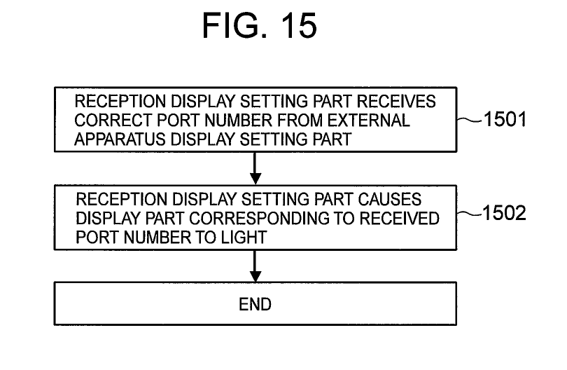

FIG. 15 is a flowchart of the processing of the reception display setting part 218.

First, the reception display setting part 218 receives correct connection destination information (the number of the correct connection-destination port) from the external apparatus display setting part 208 (Step 1501).

Next, the reception display setting part 218 instructs the display part (222, 223, 224, or 225) corresponding to the received port number to execute a display (Step 1502).

According to this example, in a case where a cable is misconnected, a display part (for example, an LED) near the port to which this cable is connected on the server chassis side lights up, and the display part (for example, an LED) near the correct connection-destination port on the I/O expansion apparatus lights up. In accordance with this, the user can tell that the port near the display part that is lit up on the server chassis side is the port for which the cable is misconnected, and can tell that the port near the display part that is lit up on the I/O expansion apparatus is the correct connection-destination port.

### Example 2

Example 2 of the present invention will be explained hereinbelow. In so doing, the explanation will focus on the difference(s) with Example 1, and explanations of the points in common with Example 1 will either be simplified or omitted (This will also hold true for Example 3 that follows).

Example 2 makes it possible to show the user the correct connection destination of a cable that is to be newly connected. That is, it is possible to let the user know the correct connection destination of a cable.

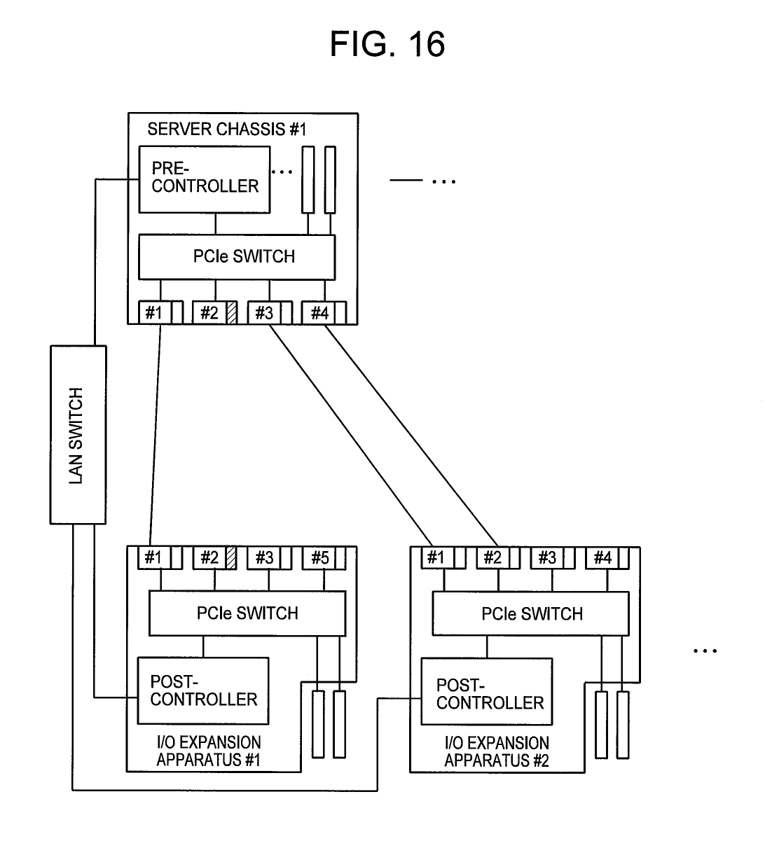

FIG. 16 is a block diagram of a system when the port on the server chassis side, which is to undergo a misconnection check, is not connected via a cable to a port on the I/O expansion apparatus.

A cable is not connected to port number “2” on the server chassis side. The user wants to connect a cable to the port of this port number “2”, and wants to connect this cable to the correct connection-destination port (port of the I/O expansion apparatus) for this port.

In accordance with this, the server chassis pre-controller may light up the display part corresponding to the relevant port number “2” when the misconnection check is to be performed for the relevant port number “2”, and regardless of whether or not the cable is connected, may light up the display part corresponding to port number “2” disposed in the I/O expansion apparatus, which is the correct connection destination of the relevant port number “2”.

Specifically, the pre-controller may perform the following processing:

(*) identify the correct connection destination information (connection-destination apparatus ID “1” and connection-destination port number “2”) corresponding to the port number “2” from the correct connection destination table;

(*) identify the unique IP address corresponding to the identified apparatus ID;

(*) send the above-mentioned identified correct connection destination information (for example, the connection-destination port number “2”) using the identified IP address (correct connection-destination I/O expansion apparatus) as the destination; and

(*) light up the display part near the port (the server chassis port) of port number “2”.

The post-controller of the correct connection-destination I/O expansion apparatus may receive the correct connection destination information (for example, the connection-destination port number “2”), and may light up the display part near the port of the port number “2” in this I/O expansion apparatus.

In accordance with this, the user can tell that the cable should be connected between the port near the display part that is lit up on the server chassis and the port near the display part that is lit up on the I/O expansion apparatus.

### Example 3

Example 3 makes it possible to show the user a misconnected cable and the correct connection destination by lighting a display part on only one of either the server chassis side or the I/O expansion apparatus side.

Specifically, for example, in Example 3, it is not necessary to light up a display part on the server chassis (there need not be a display part for each port on the server chassis); the user can be shown the misconnected cable and the correct connection destination by lighting up only a display part on the I/O expansion apparatus.

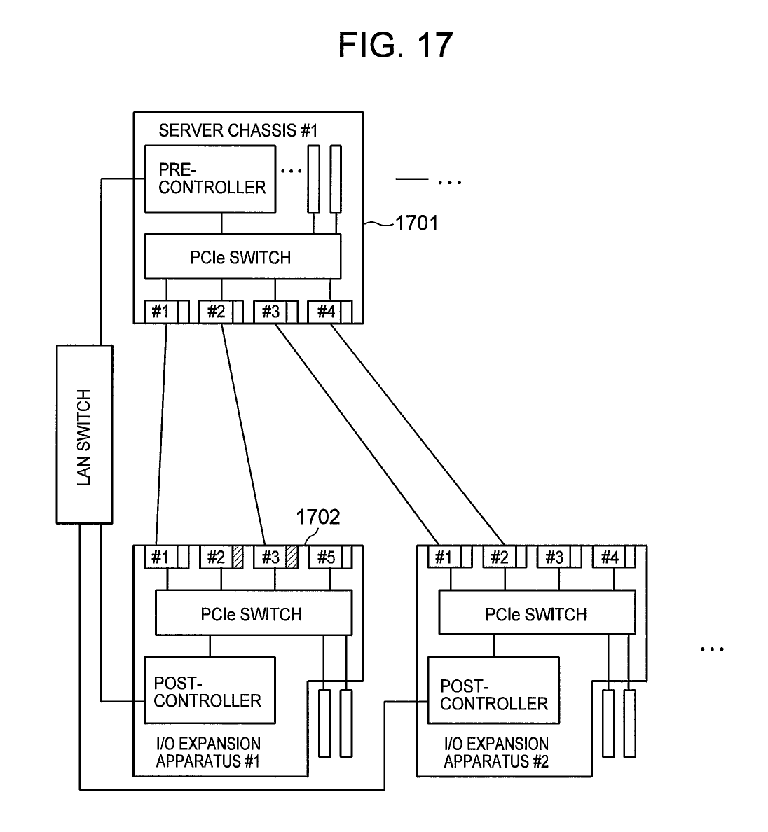

FIG. 17 shows an example of the configuration when a cable has been misconnected in Example 3.

The port of port number “3” on the I/O expansion apparatus 1702 is incorrectly connected via a cable to the port of the port number “2” of the server chassis 1701. Actually, the port of port number “2” of the I/O expansion apparatus 1702 should be connected to the port of port number “2” on the server chassis 1701.

In accordance with this, the display part, which is near the port number “3” of the I/O expansion apparatus 1702 lights up “red”, which is the color that denotes a misconnection, and the display part, which is near the port of port number “2” of the I/O expansion apparatus 1702 lights up “green”, which is the color that denotes the correct connection destination. In Example 3, for example, each display part (the display part for each port) in the I/O expansion apparatus comprises a red LED and a green LED. Lighting up “red” refers to turning ON the red LED, and lighting up “green” refers to turning ON the green LED.

Next, the processing for respectively lighting up the display parts for the misconnected port and the correct connection-destination port on the I/O expansion apparatus will be explained.

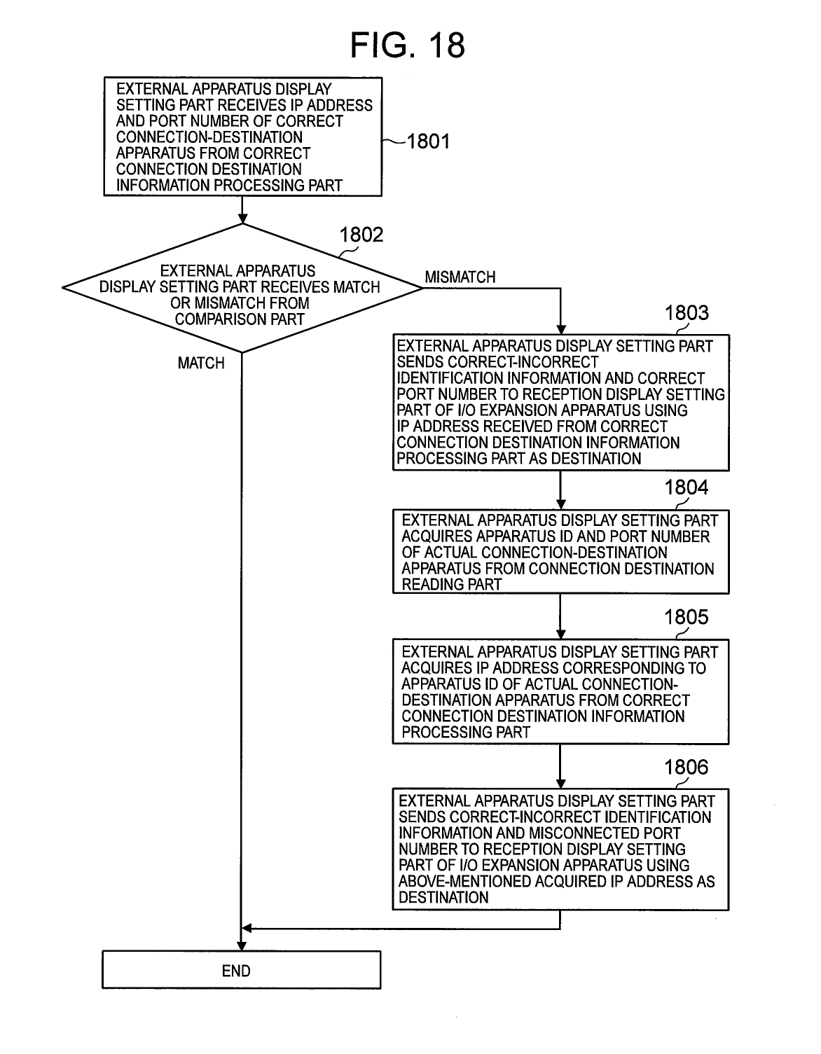

FIG. 18 is a flowchart of the processing of the external apparatus display setting part 208 disposed in the server chassis.

First, the external apparatus display setting part 208 receives the correct connection-destination apparatus IP address and correct connection destination information (the port number of the correct connection destination) from the correct connection destination information processing part 205 (Step 1801).

Next, the external apparatus display setting part 208 receives a comparison result as to whether or not the cable is correctly connected from the comparison part 206 (Step 1802).

In a case where the comparison result received in Step 1802 is mismatch here (that is, a case in which the cable is misconnected), the external apparatus display setting part 208 sends the correct connection destination information (the number of the correct connection-destination port) using the IP address (the correct connection-destination I/O expansion apparatus) received from the correct connection destination information processing part 205 as the destination (Step 1803). In so doing, together with the above-mentioned correct connection destination information, the external apparatus display setting part 208 also sends correct-incorrect identification information signifying correct as the correct-incorrect identification information, which is information that makes it possible to identify between correct and incorrect.

Next, the external apparatus display setting part 208 acquires actual connection destination information (an apparatus ID and a port number) from the connection destination reading part 217 (Step 1804).

Next, the external apparatus display setting part 208 identifies from the destination management table the IP address corresponding to the apparatus ID in the actual connection destination information from the correct connection destination information processing part 205 (Step 1805).

Next, the external apparatus display setting part 208 sends the actual connection destination information (number of the misconnected port) using the IP address identified in Step 1805 (the I/O expansion apparatus comprising the misconnected port) as the destination (Step 1806). In so doing, together with the above-mentioned actual connection destination information, the external apparatus display setting part 208 also sends correct-incorrect identification information signifying incorrect as the correct-incorrect identification information, which is information that makes it possible to identify between correct and incorrect.

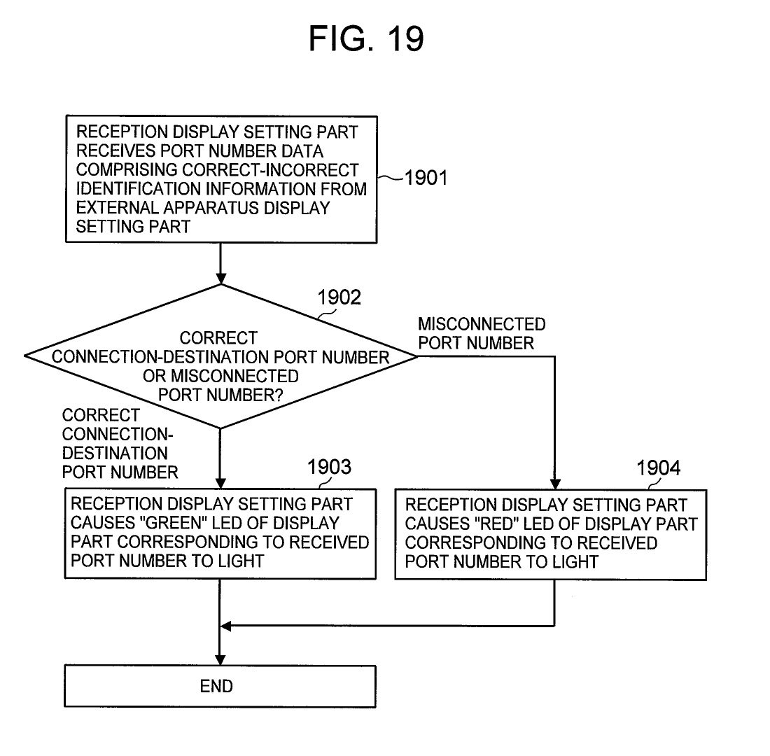

FIG. 19 is a flowchart of the processing of the reception display setting part 218 disposed in the I/O expansion apparatus.

First, the reception display setting part 218 receives either correct connection destination information (the number of the correct connection-destination port) or actual connection destination information (the number of the misconnected port), and correct-incorrect identification information from the external apparatus display setting part 208 (Step 1901).

Next, the reception display setting part 218 determines whether the received port number is the correct connection-destination port number or the misconnected port number based on the correct-incorrect identification information (Step 1902).

At this point, in a case where the result of the determination of Step 1902 is the correct connection-destination port number, the reception display setting part 218 lights up the “green” display part corresponding to the correct connection-destination port number (Step 1903).

Alternatively, in a case where the result of the determination of Step 1902 is the misconnected port number, the reception display setting part 218 lights up the “red” display part corresponding to the misconnected port number (Step 1904).

In accordance with Example 3 above, the user knows that the cable connected to the port near the display part that is lit up “red” is misconnected, and that he needs to remove this cable from this port and connect this cable to the port near the display part that is lit up “green”. This example is particularly effective when the server chassis and the I/O expansion apparatus are installed at physically separate locations.

Furthermore, the colors of the lights of the lit display parts in the I/O expansion apparatus are simply examples, and any colors may be used to distinguish between a misconnection and the correct connection destination. Further, a display that conforms to a method other than displaying different colors may also be used to distinguish between a misconnection and the correct connection destination. For example, a “blinking light” may be executed in the case of a misconnection, and an “unblinking light” may be executed in the case of a correct connection. The blinking pattern of the display part may also differ for a misconnection and a correct connection.

### Example 4

Example 4 of the present invention will be explained below. Example 4 is a combination of the Examples 1 through 3.

In Example 4, the lighting mode of the display parts of the server chassis and the I/O expansion apparatus will differ in accordance with whether or not the cable connected to the port in the server chassis that is to undergo a misconnection check is connected to any of the ports in the I/O expansion apparatus.

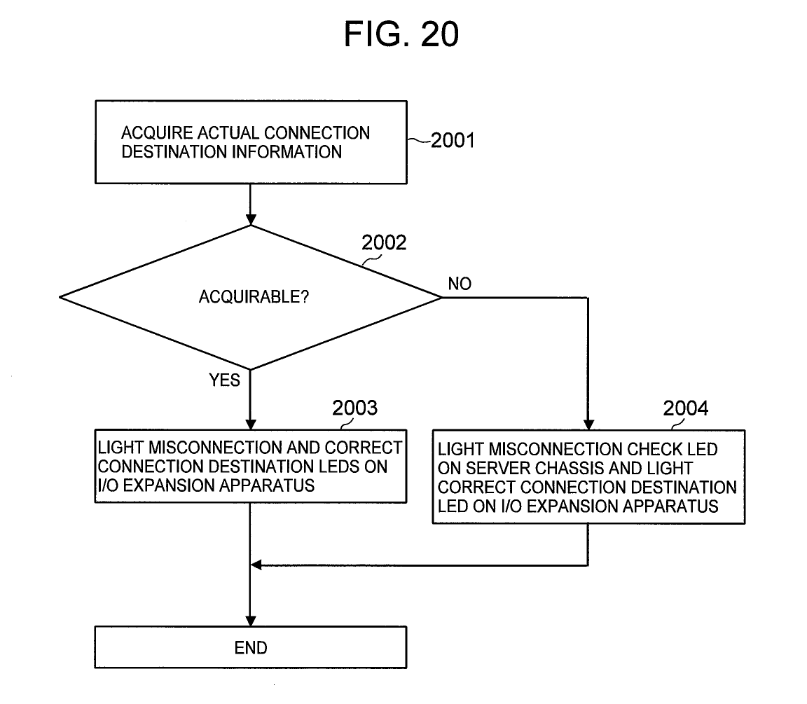

FIG. 20 is a flowchart of a lighting mode switching process.

First, the pre-controller of the server chassis attempts to acquire actual connection destination information via the port to be checked (Step 2001).

Next, the pre-controller determines whether or not it was possible to acquire the actual connection destination information (Step 2002).

At this point, in a case where the actual connection destination information was able to be acquired in Step 2002 (Step 2002: YES), the lighting process according to Example 3 is carried out. That is, the “green” display part near the correct connection-destination port of the I/O expansion apparatus is lit up, and the “red” display part near the misconnected port of the I/O expansion apparatus is lit up.

Alternatively, in a case where the actual connection destination information was not able to be acquired in Step 2002 (Step 2002: NO), the lighting processes according to the Examples 1 and 2 are carried out. That is, the display part near the check-target port of the server chassis is lit up (for example, is lit up either “green” or “red”) and the display part near the correct connection-destination port of the I/O expansion apparatus is lit up.

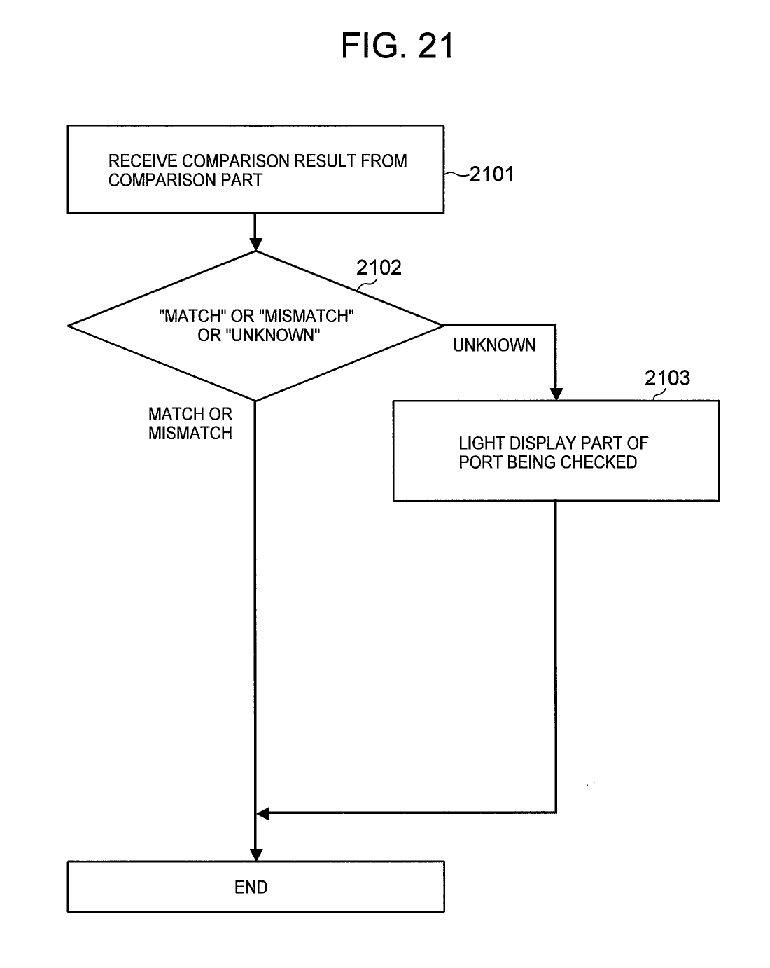

FIG. 21 is a flowchart of the processing of the internal apparatus display setting part 209 in the processing shown in FIG. 20.

First, the internal apparatus display setting part 209 receives a comparison result from the comparison part 206 (Step 2101), and determines whether the comparison result is “match”, “mismatch” or “unknown” (Step 2102). “Unknown” here is the comparison result received from the comparison part 206 when the comparison part 206 was unable to acquire the actual connection destination information via the connection destination reading part 207.

In a case where the comparison result is “unknown”, the internal apparatus display setting part 209 lights up the display part of the port corresponding to the port number n (Step 2103).

In accordance with this, in a case where either the cable is not connected to the port of port number n (the port in the server chassis) or the cable connected to the port of port number n is not connected to the I/O expansion apparatus port, the display part near the port number n port is lit up.

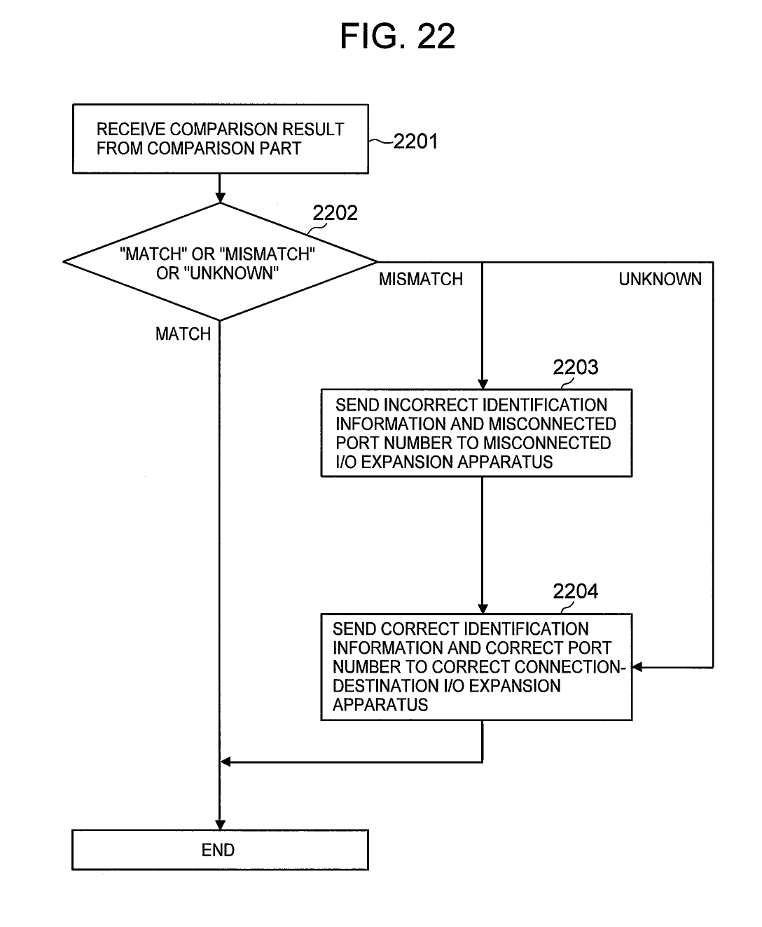

FIG. 22 is a flowchart of the processing of the external apparatus display setting part 208 in the processing shown in FIG. 20.

First, the external apparatus display setting part 208 receives a comparison result from the comparison part 206 (Step 2201), and determines whether the comparison result is “match”, “mismatch” or “unknown” (Step 2202).

In a case where the comparison result is “mismatch” (misconnection), the external apparatus display setting part 208 sends correct-incorrect identification information denoting incorrect and actual connection destination information (the number of the misconnected port) using the IP address of the misconnected I/O expansion apparatus (the apparatus ID in the actual connection destination information) as the destination (Step 2203).

Next, the external apparatus display setting part 208 sends correct-incorrect identification information signifying correct and correct connection destination information (the correct connection-destination port number) using the IP address of the correct connection-destination I/O expansion apparatus as the destination (Step 2204).

In a case where the determination result in Step 2202 is “unknown”, the external apparatus display setting part 208 skips the above-described Step 2203 and executes Step 2204.

According to Example 4, in a case where a cable is not connected to at least one of the check-target port (the port of port number n) or the I/O expansion apparatus port, the display part on the server chassis and the display part near the correct connection-destination port of the I/O expansion apparatus light up. Alternatively, in a case where a cable is connected to at least one of the check-target port (the port of port number n) or the I/O expansion apparatus port, the “green” display part near the correct connection-destination port of the I/O expansion apparatus is lit up and the “red” display part near the misconnected port of the I/O expansion apparatus is lit up without lighting up the display part near the check-target port.

According to this example, the user can find out the connection-destination port of the server chassis and the correct connection-destination port (the I/O expansion apparatus port) corresponding thereto when a cable is to be newly connected.

Then, after connecting the cable, the user can tell whether the cable is connected to an incorrect connection-destination port or a correct connection-destination port by looking at the display parts of the I/O expansion apparatus.

In addition, in a case where display parts of both the server chassis and the I/O expansion apparatus are lit despite the fact that a cable has been connected, the user can determine that perhaps this cable is disconnected (for example, the user can determine that the cable may have been removed from at least one of the server chassis port or the I/O expansion apparatus port.).

Furthermore, the pre-controller may either light or not light the display part of the server chassis when a cable has been connected. In a case where the pre-controller lights the server chassis display part, on the server chassis, the display part near the check-target port is lit, and on the I/O expansion apparatus, the “green” display part near the correct connection-destination port is lit and the “red” display part near the misconnected port is lit.

A number of examples of the present invention have been explained hereinabove, but it goes without saying that the present invention is not limited to these examples, and that various changes can be made without departing from the gist thereof.

### FIG. 1

101 Server chassis
106 Pre-controller
122 Memory
123 Port specifying program
124 Correct connection destination information creation program
125 Comparison program
126 Connection destination reading program
127 External apparatus display setting program
128 Internal apparatus display setting program
129 Correct connection destination table
103 LAN switch
109 PCIe switch
110, 112, 114, 116 Port
134, 136, 138, 140 Port
133 PCIe switch
130 Post-controller
144 Memory
146 Reception display setting program 147 ID setting program

### FIG. 2

201 Server chassis
204 Port specifying part
205 Correct connection destination information processing part
206 Comparison part
207 Connection destination reading part
208 External apparatus display setting part
209 Internal apparatus display setting part
210, 211, 212, 213 Display part
214, 215, 216, 217 Port
222, 223, 224, 225, 234, 235, 236, 237 Port
226, 227, 228, 229, 230, 231, 232, 233 Display part
218, 220 Reception display setting part
219, 221 ID setting part
202, 203 I/O expansion apparatus

### FIG. 3

Server chassis port number
Connection-destination apparatus ID
Connection-destination port number

### FIG. 4

Original address
Connection-destination apparatus ID
Created address

### FIG. 5

501 Server chassis
503 Pre-controller
515 PCIe switch
518 LAN switch
502, 519 I/O expansion apparatus
516, 520 PCIe switch
504, 517 Post-controller

### FIG. 6

501 Server chassis
503 Pre-controller
515 PCIe switch
518 LAN switch
502, 519 I/O expansion apparatus
516, 520 PCIe switch
504, 517 Post-controller

### FIG. 7

501 Server chassis
503 Pre-controller
515 PCIe switch
518 LAN switch
502, 519 I/O expansion apparatus
516, 520 PCIe switch
504, 517 Post-controller

### FIG. 8

801 Port specifying part specifies port number n to be checked
802 Port specifying part sends port number n, which will undergo check, to internal apparatus display setting part
803 Port specifying part sends port number n, which will undergo check; to correct connection destination information processing part
804 Correct connection destination information processing part refers to correct connection destination table stored in memory, and sends apparatus ID and port number of correct connection-destination apparatus to comparison part
805 Correct connection destination information processing part refers to correct connection destination table and creates IP address by adding value of apparatus ID to host part of original IP address
806 Correct connection destination information processing part sends created IP address and port number to external apparatus display setting part
807 Port specifying part sends port number n, which will undergo check, to connection destination reading part
808 Connection destination reading part acquires apparatus ID and connected port number held in ID setting part of connection-destination apparatus connected to actual port number n
809 Connection destination reading part sends actual connection-destination apparatus ID and port number to comparison part
810 Comparison part compares apparatus ID and port number of actual connection-destination apparatus to correct apparatus ID and port number

### Match

811 Comparison part sends fact that connection is normal to internal apparatus display setting part and external apparatus display setting part

### Mismatch

812 Comparison part sends fact that connection is mismatch to internal apparatus display setting part
813 Internal apparatus display setting part lights up display part of port number n
814 Comparison part sends face the connection is mismatch to external apparatus display setting part
815 External apparatus display setting part sends port number to reception display setting part of I/O expansion apparatus using IP address received from correct connection destination information processing part as destination
816 Reception display setting part of correct connection-destination apparatus lights display part of received port number

### End

### FIG. 9

901 Port specifying part specifies port number n to undergo connection check
902 Port specifying part sends port number n, which will undergo check, to internal apparatus display setting part
903 Port specifying part sends port number n, which will undergo check, to correct connection destination information processing part
904 Port specifying part sends port number n, which will undergo check, to connection destination reading part

### End

### FIG. 10

1001 Correct connection destination information processing part receives port number n to undergo check from port specifying part
1002 Correct connection destination information processing part refers to correct connection destination table stored in memory and sends apparatus ID and port number of correct connection-destination apparatus to comparison part
1003 Correct connection destination information processing part refers to correct connection destination table and creates IP address by adding value of apparatus ID to host part of original IP address
1004 Correct connection destination information processing part sends created IP address and port number to external apparatus display setting part

### End

### FIG. 11

1101 Connection destination reading part receives port number n to undergo check from port specifying part
1102 Connection destination reading part acquires apparatus ID and connected port number held in ID setting part of connection-destination apparatus actually connected to port number n
1103 Connection destination reading part sends apparatus ID and port number of actual connection-destination apparatus to comparison part

### End

### FIG. 12

1201 Comparison part receives apparatus ID and port number of correct connection-destination apparatus from correct connection destination information processing part
1202 Comparison part receives apparatus ID and port number of actual connection-destination apparatus from connection destination reading part
1203 Comparison part compares apparatus ID and port number of actual connection-destination apparatus to correct apparatus ID and port number

### Match

1204 Comparison part sends connection normal to internal apparatus display setting part
1205 Comparison part sends connection normal to external apparatus display setting part

### Mismatch

1206 Comparison part sends connection mismatch to internal apparatus display setting part
1207 Comparison part sends connection mismatch to external apparatus display setting part

### End

### FIG. 13

1301 Internal apparatus display setting part receives port number n to undergo check from port specifying part
1302 Internal apparatus display setting part receives match or mismatch from comparison part

### Mismatch

1303 Internal apparatus display setting part lights display part corresponding to port number n

### Match

### End

### FIG. 14

1401 External apparatus display setting part receives IP address and port number of correct connection-destination apparatus from correct connection destination information processing part
1402 External apparatus display setting part match or mismatch from comparison part

### Mismatch

1403 External apparatus display setting part sends port number of correct connection destination to reception display setting part of I/O expansion apparatus using IP address received from correct connection destination information processing part as destination

### Match

### End

### FIG. 15

1501 Reception display setting part receives correct port number from external apparatus display setting part
1502 Reception display setting part causes display part corresponding to received port number to light

### End

### FIG. 16

Server chassis
Pre-controller
PCIe switch
LAN switch
PCIe switch
Post-controller
I/O expansion apparatus

### FIG. 17

Server chassis
Pre-controller
PCIe switch
LAN switch
PCIe switch
Post-controller
I/O expansion apparatus

### FIG. 18

1801 External apparatus display setting part receives IP address and port number of correct connection-destination apparatus from correct connection destination information processing part
1802 External apparatus display setting part receives match or mismatch from comparison part

### Mismatch

1803 External apparatus display setting part sends correct-incorrect identification information and correct port number to reception display setting part of I/O expansion apparatus using IP address received from correct connection destination information processing part as destination
1804 External apparatus display setting part acquires apparatus ID and port number of actual connection-destination apparatus from connection destination reading part
1805 External apparatus display setting part acquires IP address corresponding to apparatus ID of actual connection-destination apparatus from correct connection destination information processing part
1806 External apparatus display setting part sends correct-incorrect identification information and misconnected port number to reception display setting part of I/O expansion apparatus using above-mentioned acquired IP address as destination

### Match

### End

### FIG. 19

1901 Reception display setting part receives port number data comprising correct-incorrect identification information from external apparatus display setting part
1902 Correct connection-destination port number or misconnected port number?
Correct connection-destination port number
1903 Reception display setting part causes “green” LED of display part corresponding to received port number to light
Misconnected port number
1904 Reception display setting part causes “red” LED of display part corresponding to received port number to light

### End

### FIG. 20

2001 Acquire actual connection destination information
2002 Acquirable?
2003 Light misconnection and correct connection destination LEDs on I/O expansion apparatus
2004 Light misconnection check LED on server chassis and light correct connection destination LED on I/O expansion apparatus

### End

### FIG. 21

2101 Receive comparison result from comparison part
2102 “Match” or “Mismatch” or “Unknown”

### Unknown

2103 Light display part of port being checked
Match or Mismatch

### End

### FIG. 22

2201 Receive comparison result from comparison part
2202 “Match” or “Mismatch” or “Unknown”

### Mismatch

2203 Send incorrect identification information and misconnected port number to misconnected I/O expansion apparatus

### Unknown

2204 Send correct identification information and correct port number to correct connection-destination I/O expansion apparatus
   End

What is claimed is:

1. A computer system comprising:
one or more first apparatuses, which have multiple first ports;
one or more second apparatuses, which are connected via multiple cables to the one or more first apparatuses, and have multiple second ports and a second display apparatus; and
a control apparatus, wherein
the control apparatus has correct connection management information denoting, for each of the first ports, identification information on a second port, which is a correct connection destination for a first port, and
the control apparatus:
(A) identifies, from the correct connection management information, identification information of the second port that is the correct connection destination of a target first port, which is a check-target first port of the multiple first ports;
(B) identifies the identification information of a second port, which is connected via a cable to the target first port;
(C) determines the correctness or incorrectness of the second port, which is a connection destination of the target first port, based on the second port identification information identified in the (A) and the second port identification information identified in the (B); and
(D) in a case where the second port identification information identified in the (A) and the second port identification information identified in the (B) do not match, causes the second display apparatus to execute a display with respect to the second port identified from the second port identification information identified in the (A).

2. A computer system according to claim 1, wherein
the control apparatus comprises a first controller and a second controller,
each of the one or more first apparatuses has the first controller,
each of the one or more second apparatuses has the second controller,
the first controller has a first communication part, the second controller has a second communication part, the first controller and the second controller are coupled via the first communication part and the second communication part in use of a communication path that is not the cable,
the first controller executes the processing of the (A) through (C), and
in the (D):
(d1) the first controller, in a case where a result of the determination in the (C) is negative, sends the second port identification information identified in the (A) via the first communication part to the second apparatus having the second port identified from the second port identification information identified in the (A); and
(d2) the second controller receives the second port identification information identified in the (A), and causes the second display part to execute a display with respect to the second port identified from this received second port identification information.

3. A computer system according to claim 2, wherein in the (d1):
(d1-1) the first controller sends the second port identification information identified in the (A) and correct connection identification information denoting that the connection destination is correct, via the first communication part, to a second apparatus having a second port identified from the second port identification information identified in the (A); and, in addition,
(d1-2) the first controller sends the second port identification information identified in the (B) and misconnection identification information denoting that the connection destination is incorrect, via the first communication part, to the second apparatus having a second port identified from the second port identification information identified in the (B), and
in the (d2):
(d2-1) the second controller, which receives the correct identification information and the second port identification information identified in the (A), causes the second display part to execute a display signifying that a second port identified from this received second port identification information is the correct connection destination; and
(d2-2) the second controller, which receives the incorrect identification information and the second port identification information identified in the (B), causes the second display part to execute a display signifying that the second port identified from this received second port identification information is the incorrect connection destination.

4. A computer system according to claim 3, wherein
the first apparatus has a first display apparatus,
in the (B), the first controller identifies identification information of the second port connected to the target first port by acquiring the identification information of the second port connected to the target first port via the cable from this second port and the target first port,
in a case where the identification information of the second port connected to the target first port cannot be acquired,
(E) the first controller causes the first display apparatus to execute a display with respect to the target first port;
(F) the first controller sends the second port identification information identified in the (A) and correct connection identification information denoting that the connection destination is correct, via the first communication part, to the second apparatus having the second port identified from the second port identification information identified in the (A); and
(G) the second controller, which receives the correct identification information and the second port identification information identified in the (A), causes the second display part to execute a display signifying that the second port identified from this received second port identification information is the correct connection destination.

5. A computer system according to claim 4, wherein
the first display apparatus is multiple first display parts respectively corresponding to the multiple first ports,
the second display apparatus is multiple second display parts respectively corresponding to the multiple second ports,
in the (E), the first display part corresponding to the target first port executes a display,
in the (D) and (G), the second display part corresponding to the second port identified from the second port identification information executes a display, and
a display mode of the second display part corresponding to the second port identification information, which corresponds to the correct connection identification information, differs from a display mode of the second display part corresponding to the second port identification information, which corresponds to the incorrect connection identification information.

6. A computer system according to claim 1, wherein
the first apparatus has a first display apparatus, and
in addition to the processing of the (A) through (D), the following processing is also carries out:
(X) the first controller causes the first display apparatus to executes a display with respect to the target first port.

7. A computer system according to claim 1, wherein in the (D):
(d1) the control apparatus causes the second display apparatus in the second apparatus, which has the second port identified from the second port identification information identified in the (A), to execute a display signifying that the second port identified from the second port identification information identified in the (A) is the correct connection destination; and
(d2) the control apparatus causes the second display apparatus in the second apparatus, which has the second port identified from the second port identification information identified in the (B), to execute a display signifying that the second port identified from the second port identification information identified in the (B) is the incorrect connection destination.

8. A computer system according to claim 2, wherein
the second port identification information identified in the (B) is information identified via a cable that is connected to the target first port, and
the control apparatus, in a case where the identification information of the second port connected to the target first port cannot be acquired:
(E) causes the first display apparatus to execute a display with respect to the target first port; and
(F) causes the second display apparatus in the second apparatus, which has the second port identified from the second port identification information identified in the (A), to execute a display signifying that the second port identified from the second port identification information identified in the (A) is the correct connection destination.

9. An apparatus comprising:
one or more first ports, which are connected via one or more cables to any one or more second ports of multiple second ports of one or more second apparatuses having a display apparatus; and
a controller, which is connected to the one or more first ports, wherein
the controller has correct connection management information denoting, for each of the first ports, identification information of a second port, which is the correct connection destination of a first port and
the controller:
(A) identifies, from the correct connection management information, identification information of the second port that is the correct connection destination of a target first port, which is a check-target first port of one or more first ports;
(B) acquires via a cable the identification information of the second port, which is connected via this cable to the target first port;
(C) determines the correctness or incorrectness of the second port, which is the connection destination of the target first port, based on the second port identification information identified in the (A) and the second port identification information acquired in the (B); and
(D) in a case where the second port identification information identified in the (A) and the second port identification information identified in the (B) do not match, sends the second port identification information identified in the (A) to the second display apparatus having the second port identified from the second port identification information identified in the (A) such that a display with respect to this second port is executed in the display apparatus in accordance with the second apparatus.

10. An apparatus according to claim 9, comprising a first communication part, which is coupled to a second communication part of the second apparatus, wherein
in the (D), the controller sends the second port identification information identified in the (A) via the first communication part.

11. A cable misconnection check method, which is performed with respect to a system in which multiple first ports of one or more first apparatuses and multiple second ports of one or more second apparatuses that have a display apparatus are connected via two or more cables,
the method comprising:
(A) identifying for each of the first ports, from correct connection management information denoting the identification information of a second port which is a correct connection destination of a first port, the identification information of the second port that is a correct connection destination of a target first port, which is a check-target first port of the multiple first ports;
(B) identifying the identification information of the second port, which is connected via a cable to the target first port;
(C) determining the correctness or incorrectness of the second port, which is the connection destination of the target first port, based on the second port identification information identified in the (A) and the second port identification information identified in the (B); and
(D) causing the display apparatus to execute a display with respect to the second port identified from the second port identification information identified in the (A) in a case where the second port identification information identified in the (A) and the second port identification information identified in the (B) do not match.
